(19) United States
(12) Patent Application Publication
(10) Pub. No.: US 2012/0041818 A1
(43) Pub. Date: Feb. 16, 2012

(54) AD YIELD ARBITRATION ENGINE FOR ONLINE RETAILERS

(75) Inventors: Matthew John Symons, Oakland, CA (US); Milton Merl, New York, NY (US)

(73) Assignee: ACCENTURE GLOBAL SERVICES GMBH, Schaffhausen (CH)

(21) Appl. No.: 12/853,913

(22) Filed: Aug. 10, 2010

(51) Int. Cl. G06Q 30/00

(52) U.S. Cl. 705/14.46; 705/1.1

(57) ABSTRACT

A system for determining whether to present an online bid content from a prequalified value chain entity at a virtual point-of-decision on a web site includes an online customer database storing online customer data, a product manufacturer database storing prequalified value chain entity profiles and a dynamic arbitration engine. The dynamic arbitration engine determines whether a customer is at the virtual point-of-decision on the web site, a customer segment of the customer based on the online customer data, a next most profitable action based on the customer segment of the customer, prequalified value chain entities based on product manufactured and the bid content that may be presented to the customer at the virtual point-of-decision based on the customer segment of the customer and a product type. The dynamic arbitration engine also inserts the bid content at the virtual point-of-decision.

### BACKGROUND

Traditional brick and mortar retailers have focused on attracting, generating and rewarding demand by depending on a mass marketing and merchandizing model that seeks to satisfy a broad and homogeneous customer base. However, relatively recently, traditional brick and mortar retailers are seeking to treat the customers in their market as unique individuals and family groups because they can no longer afford to compete under the traditional business model. Therefore, traditional brick and mortar retailers are investing more substantially in strategies to grow their market by enhancing customer lifetime value. Customer lifetime value is the present value of the future cash flows related to a customer relationship over the lifetime of that relationship. Thus, investing in growing customer lifetime value involves implementing strategies to gain and keep customers based on their value, unique behaviors and needs.

This new model is dependent upon traditional brick and mortar retailers “talking to and serving customers” on a one-to-one basis. The first generation of this emerging business model is embodied in retailer loyalty and rewards programs and online retail channels featuring advertisements, coupons, discounts, etc. (generally ads). Retailers are now moving to the second and third generations of this one-to-one business model. Online store environments are being utilized heavily by brick and mortar retailers and are now advancing in sophistication by customizing product assortments, price, and customer rewards to meet known customer preferences.

Also, traditional brick and mortar retailers are starting to consider methods to shift customer purchase decisions away from the physical world to the virtual, thus preempting a physical world decision and enabling a more personal merchandizing connection through the virtual world. However, even if a retailer is successful in moving purchasing decisions to a virtual point-of-decision, the retailer may only marginally increase profits. This is because conventional customer centric-modeling may suggest product recommendations be made to customers that may be unrelated to available product options and unrelated to growing customer lifetime value. Moreover, ads presented on the retailer's web site may not be aligned with growing customer lifetime value.

### SUMMARY OF THE INVENTION

According to an embodiment, a system for determining whether to present online bid content from a prequalified value chain entity at a virtual point-of-decision on a web site includes an online customer database, a product manufacturer database and a dynamic arbitration engine. The online customer database stores online customer data and the product manufacturer database stores prequalified value chain entity profiles. The dynamic arbitration engine includes a virtual point-of-decision module configured to determine whether a customer is at the virtual point-of-decision on the web site; a customer segmentation module configured to determine a customer segment of the customer based on the online customer data; a customer-centric modeling module configured to determine a next most profitable action based on the customer segment of the customer; a prequalified value chain entities determination module configured to determine prequalified value chain entities based on product manufactured; a bid content determination module configured to determine the bid content that may be presented to the customer at the virtual point-of-decision based on the customer segment of the customer and a product type; and an bid content insertion module configured to insert the bid content determined by the bid content determination module at the virtual point-of-decision.

According to an embodiment, a method for determining whether to present online bid content from a prequalified value chain entity at a virtual point-of-decision on a web site includes determining, by a computer system, whether a customer is at the virtual point-of-decision on the web site and determining a customer segment of the customer based on online customer data. The method further includes determining a next most profitable action based on the customer segment of the customer and determining prequalified value chain entities based on product manufactured by the prequalified value chain entities. The method also includes determining bid content operable to be presented to the customer at the virtual point-of-decision based on the customer segment of the customer and a product type and inserting the bid content at the virtual point-of-decision. According to an embodiment, the method described above may be embodied in a computer program stored on a non-transitory computer readable medium, which when executed by a computer system performs the method.

### BRIEF DESCRIPTION OF DRAWINGS

The embodiments of the invention will be described in detail in the following description with reference to the following figures.

FIG. 1 illustrates a diagram of a system for determining whether to present online bid content from a prequalified value chain entity at a virtual point-of-decision, according to an embodiment;

FIG. 2 illustrates a system diagram of a dynamic arbitration engine, according to an embodiment;

FIGS. 3A and 3B illustrate a method for determining whether to present online bid content from a prequalified value chain entity at a virtual point-of-decision, according to an embodiment; and

FIG. 4 illustrates a computer system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

### 1. Overview

According to an embodiment, a new revenue stream is generated at a virtual point-of-decision based on customer-centric modeling. A virtual point-of-decision is any online environment where a customer is presented with a set of product options or has selected from a set of product options, or any situation where there is a chance to influence customer. For example, the virtual point-of-decision may be an online product catalog for a category of products, e.g. T-shirts, on a retailer web site. The virtual point-of-decision may also be the point at which a customer selects a product from a product catalog. Through customer-centric modeling, a next most profitable action is determined. The next most profitable action indicates what action the retailer should take with regard to making product recommendations at the virtual point-of-decision to increase customer lifetime value. For example, the next most profitable action in terms of making product recommendations may include encouraging the customer to move the customer to house-brand products from of branded products, encouraging the customer to buy more volume in an existing product category, encouraging the customer to purchase a higher-value or higher-priced product in an existing product category, etc. By directing customer-centric modeling in which a next most profitable action is determined, customer lifetime value is substantially enhanced.

A retailer may then monetize the next most profitable action by offering the opportunity to influence the customer selection to prequalified value chain entities. The prequalified value chain entities may be a group of entities that are seeking the same outcome as the retailer and may be eligible to purchase the opportunity to influence customer selection, which may be a selection that results in the most profitable action (referred to as the next most profitable action). For example, the prequalified value entities may include any entity in the value chain including wholesalers, importers, product manufacturers, etc. For example, if the next most profitable action is to insert an ad for a higher-priced product in the same category of products in the online product catalog at the virtual point-of-decision, instead of the retailer inserting an ad for the higher-priced product at the virtual point-of-decision, a retailer may sell the opportunity to insert an ad for the higher-priced product at the virtual point-of-decision to a prequalified value chain entity that is willing to invest in this opportunity and seeks the same outcome.

The prequalified value chain entities may be different for every next most profitable action determined by the customer-centric modeling. The prequalified value chain entities may include entities in a specific geographical location, entities manufacturing a category of product, entities having product inventory, etc.

The revenue generated from selling the opportunity to influence customer selection to a prequalified value chain entity is the newly created revenue stream. For example, a retailer may determine through customer centric modeling that the next most profitable action is to insert an ad for a specific product on the retailer's web site when a specific customer selects a product from an online product catalog. Instead of the retailer inserting the ad for the product, the retailer may instead insert an ad from a prequalified value chain entity for payment.

For the prequalified value chain entities, investing in advertising opportunities at the virtual point-of-decision may be more effective than other strategies such as product placement and advertising in circulars or by the shelf, and even more valuable than other online advertising methods such as paid search. This is because the advertising is inserted at the virtual of point-of-decision, where an opportunity to influence the customer's selection exists. Thus, the new revenue stream provides the retailer with a sizeable opportunity to generate revenue from the sales of online advertising opportunities to prequalified value chain entities while still in growing customer lifetime value.

According to various embodiments, systems and methods described herein determine whether to present an online ad from a prequalified value chain entity at a virtual point-of-decision. The systems and methods include providing a customer interaction online. The systems and methods also include storing the data in a database and data manipulation. Thus, the systems and methods method may decrease the mental and physical effort required from a user in order to perform a task (e.g. storing data), since the user does not need to worry about where data is stored.

### 2. System

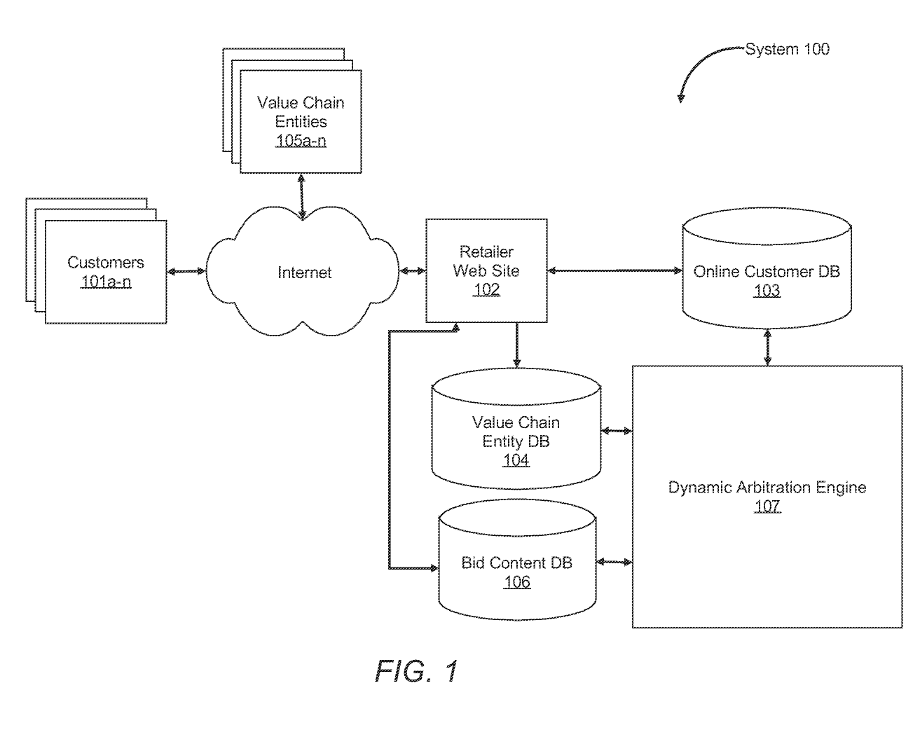

FIG. 1 illustrates a system 100 for determining whether to present online bid content from a prequalified value chain entity at a virtual point-of-decision, according to an embodiment. An example of the virtual point-of-decision may be an online product catalog on a retailer web site. The virtual point-of-decision may also be the point at which a customer selects a product from a product catalog. The virtual point-of-decision may also include selection for compilation of an online shopping list, selection for an online basket of products a customer would like to purchase, etc. The system 100 includes customers 101a-n, a retailer web site 102, an online customer database (DB) 103, a value chain entity database (DB) 104, value chain entities 105a-n, a bid content database (DB) 106 and a dynamic arbitration engine 107.

Multiple customers 101a-n may access the retailer web site 102 via the Internet. For each of the customers 101a-n online customer data is collected. For example, for customer 101a, online customer data may include attributes of the customer 101a including family information, gender, geographical location, buying habits, customer tracking information such as current location of the customer 101a in the retailer web site 102, etc. The online customer data is stored in the online customer DB 103. The online customer data may be captured and stored for any of the customers 101a-n. The online customer data may be an input to the dynamic arbitration engine 107.

In addition to the online customer DB 103, the system 100 includes the value chain entity DB 104. The value chain entity DB 104 stores profiles of the various value chain entities 105a-n. The profiles of the value chain entities 105a-n stored in the value chain entity DB 104 may include name, contact information, a list of products manufactured, system login information, an inventory of products, etc.

The value chain entities 105a-n may submit advertisements, discounts, coupons, etc. (generally bid content) for products they handle to the system 100. The content is referred to as “bid” content because the content is submitted to the system 100 with a purchase price (i.e., an offer to purchase at the purchase price) from a value chain entity, and the system 100 may select one of many offers. The “bid” does not necessarily imply the offers are submitted for an auction. An offer may be selected based on factors described below. The submitted bid content are stored in the bid content DB 106. The bid content may include product name, product type, product manufacturer name, customer segment bid content is related to, a virtual point-of-decision the bid content may be used for, etc. The bid content may be submitted to the bid content DB 106 on an ad hoc basis or in response to a request from the retailer. The bid content stored in the bid content DB 106 may be accessed by the dynamic arbitration engine 107 as further discussed below.

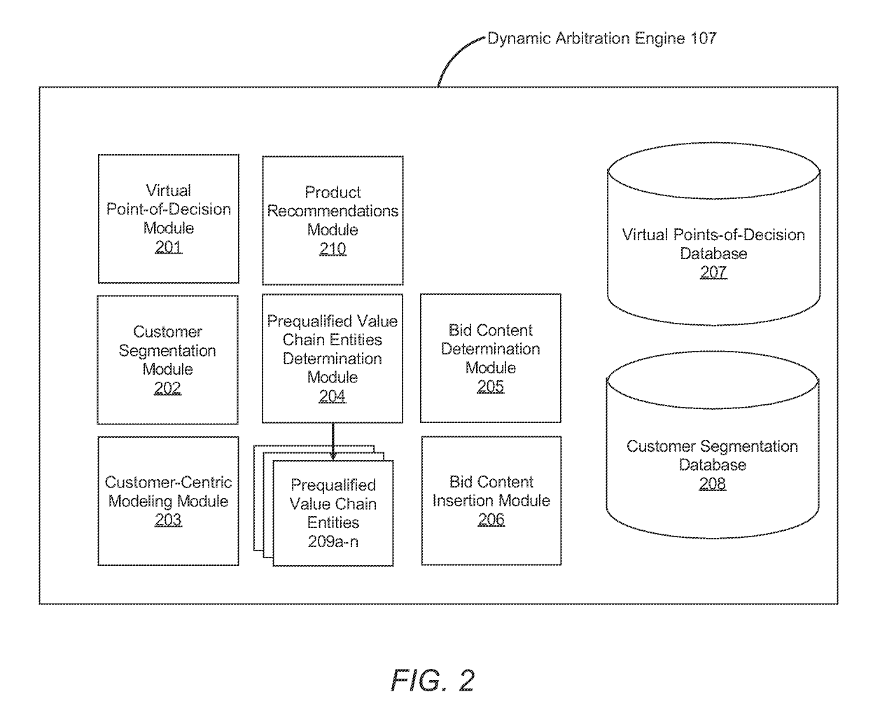

According to an embodiment, the dynamic arbitration engine 107 determines whether to present online bid content from a prequalified value chain entity at a virtual point-of-decision. The dynamic arbitration engine 107 includes several components, i.e. modules, that may be implemented as software, hardware or a combination of both software and hardware. The dynamic arbitration engine 107, illustrated in more detail in FIG. 2, includes a virtual point-of-decision module 201, a customer segmentation module 202, a customer-centric modeling module 203, a prequalified value chain entities determination module 204, a bid content determination module 205, a bid content insertion module 206, a virtual points-of-decision database 207, a customer segmentation database 208 and a product recommendations module 210.

The virtual point-of-decision module 201 of FIG. 2 determines whether one of the customers 101a-n, such as customer 101a, is at a virtual point-of-decision. As discussed above, the virtual point-of-decision is any online environment where a customer is presented with a set of product options or has selected from a set of product options, and an opportunity to influence customer selection exists. For example, the virtual point-of-decision may be an online product catalog on the retailer web site 102. The virtual point-of-decision may also be the point at which a customer selects a product from a product catalog, for example, to place the product in a shopping basket or to compile a shopping list. To determine whether the customer 101a is at a virtual point-of-decision, the virtual point-of-decision module 201 retrieves the online customer data for the customer 101a from the online customer DB 103. As discussed above, the online customer data may include an attributes describing a current location in the retailer web site 102. The attribute describing the current location of the customer 101a in the web site 102 is compared with known virtual points-of-decision of the retail web site 102. The known virtual point-of-decision are stored in the virtual points-of-decision database 207. If attribute describing the current location of the customer 101a in the web site 102 matches a known virtual point-of-decision from the virtual points-of-decision database 207, the customer 101a is at a virtual point-of-decision.

If, however, the virtual point-of-decision module 201 does not find a matching known virtual-point-of decision, the customer 101a is not at a virtual-point-of-decision. The product recommendations module 210 then prepares and presents product recommendations for the customer 101a on the retailer web site 102. The product recommendations made by the product recommendations module 210 may include product features, coupons, or other calls to action for a product not within a category of product that the customer 101a already purchases. The categories of products that the customer 101a currently purchases is determined from corresponding online customer data retrieved from the online customer DB 103. For example, if the customer 101a does not currently purchase grocery products from the retailer web site 102, the product recommendations made to the customer 101a on the retailer web site 102 may include coupons for grocery products, i.e. a category of products the customer 101a does not currently purchase.

For customers 101a-n at a virtual point-of-decision, such as the customer 101a, the customer segmentation module 202 retrieves the online customer data for the customer 101a at the virtual point-of-decision from the virtual point-of-decision 201. The customer segmentation module 202 may then determine a customer segment that corresponds to the attributes in the online customer data for the customer 101a at the virtual point-of-decision. For example, if the online customer data indicates that the customer 101a is a 24-year old male in Seattle, Wash., the customer segmentation module 202 may determine the customer 101a is in the “18-24-Year Old Males in Northwest U.S.” customer segment. The customer segmentation module 202 stores a correlation between each of the customers 101a-n and the corresponding customer segment determined by the customer segment module 202 in the customer segmentation database 208.

Once the customer segment for the customer 101a at the virtual point-of-decision is determined, the customer-centric modeling module 203 determines a next most profitable action to take with regard to the customer 101a. As discussed above, customer-centric modeling takes into account growing customer lifetime value in determining the next most profitable action. The customer-centric modeling module 203 determines the next most profitable action to take with regard to the customer 101a at the virtual point-of-decision to grow customer lifetime value based on historical models, customer behavior and purchase data, etc. For example, the next most profitable action may include implementing a strategy to move the customer to a house-brand product from a branded product, to encourage the customer to buy more volume in an existing product category, etc. based on historical models showing what a customer in the customer segment would do if presented with the next most profitable action at the virtual point-of-decision.

The prequalified value chain entities determination module 204 determines prequalified value chain entities 209a-n from the value chain entities 105a-n. The prequalified value chain entities 209a-n are determined based on data from the profiles of the value chain entities 105a-n retrieved from the value chain entity DB 104. As discussed above, the profiles of the value chain entities 105a-n include “products manufactured” data. The products manufactured are compared with the product recommendation with the next most profitable action. If the products manufactured data matches the next most profitable action product recommendation, the value chain entity is the one of the prequalified value chain entities 209a-n. The retailer may also require other criteria of the value chain entities 105a-n to be prequalified value chain entities 209a-n, such as the prequalified value chain entities 209a-n have an inventory of the product, the prequalified value chain entities 209a-n be in a specific geographical location, etc. For example, if the next most profitable action is to present the customer 101a with organic strawberry options, the profiles of the product manufacturer 105a-n are retrieved that listed organic strawberries as the “products manufactured”, which indicate they are the prequalified value chain entities 209a-n.

The bid content determination module 205 scans the bid content DB 106 for online bid content submitted by any of the prequalified value chain entities 209a-n that may be inserted at the virtual point-of-decision for the customer 101a. The bid content is determined by comparing the virtual point-of-decision of the bid content, which may be determined from the bid content DB 106, to the virtual point-of-decision the customer 101a is located at, which may be determined from the online customer data from the online customer DB 104. For example, if the customer 101a is at a virtual point-of-decision where a product catalog is to be generated, the bid content may include a product to be placed in a prominent position in the product catalog. For example, the value chain entities 105a-n may submit bid content including a product to be placed in a prominent position such as a first slot in the product catalog. The product catalog may be dynamically updated including the product of the bid content in the first slot in the product catalog. If, however, the customer 101a is at a point at which the customer 101a has already selected a product to place in a shopping basket, the bid content may be an ad for a different product.

The bid content is also determined by comparing the next most profitable action and customer segment of the bid content in the bid content DB 106 with the product type and the customer segment of the customer 101a. If more than one bid content is determined to meet the scanning criteria after all bid content in the bid content DB 106 have been scanned, the bid content determination module 205 determines the bid content with the highest absolute ad yield. The bid content with the highest absolute ad yield is the bid content that may be inserted at the virtual point-of-decision for the customer 101a. Absolute ad yield is a measure of profits associated with the bid content. For example, if ad X is inserted in the retailer web site 102, the retailer receives profits in the form of sales of the advertising opportunity to the prequalified value chain entity 105a-n that submitted ad X. In another instance, if product Y is inserted in the first slot of the product catalog on the retailer web site 102, the retailer receives profits in the form of sales of the first slot placement to the prequalified value chain entity 105a-n that submitted bid content including product Y. Also, the retailer may receive profits in the form of sales based on the ad X or the product placement of product Y. Thus, absolute ad yield accounts for all profits associated with insertion of the bid content at the virtual point-of-decision for the customer 101a.

The bid content insertion module 206 inserts the bid content determined by the bid content determination module 205 at the virtual point-of-decision for the customer 101a.

### 3. Method

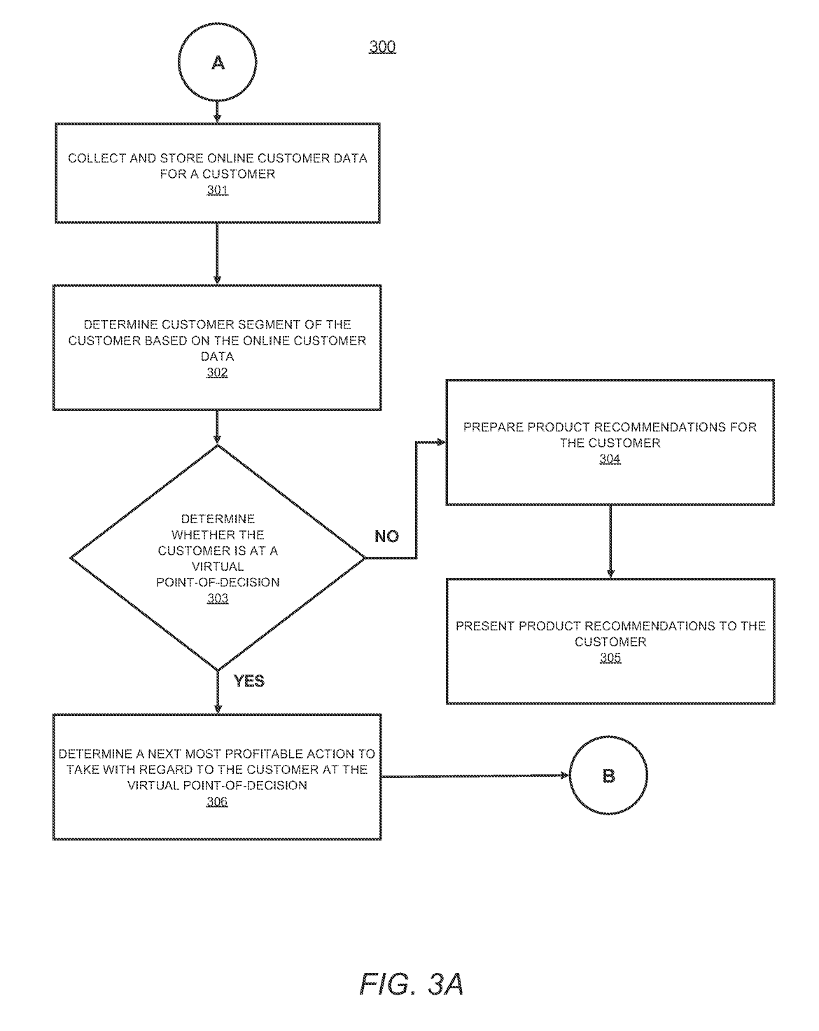

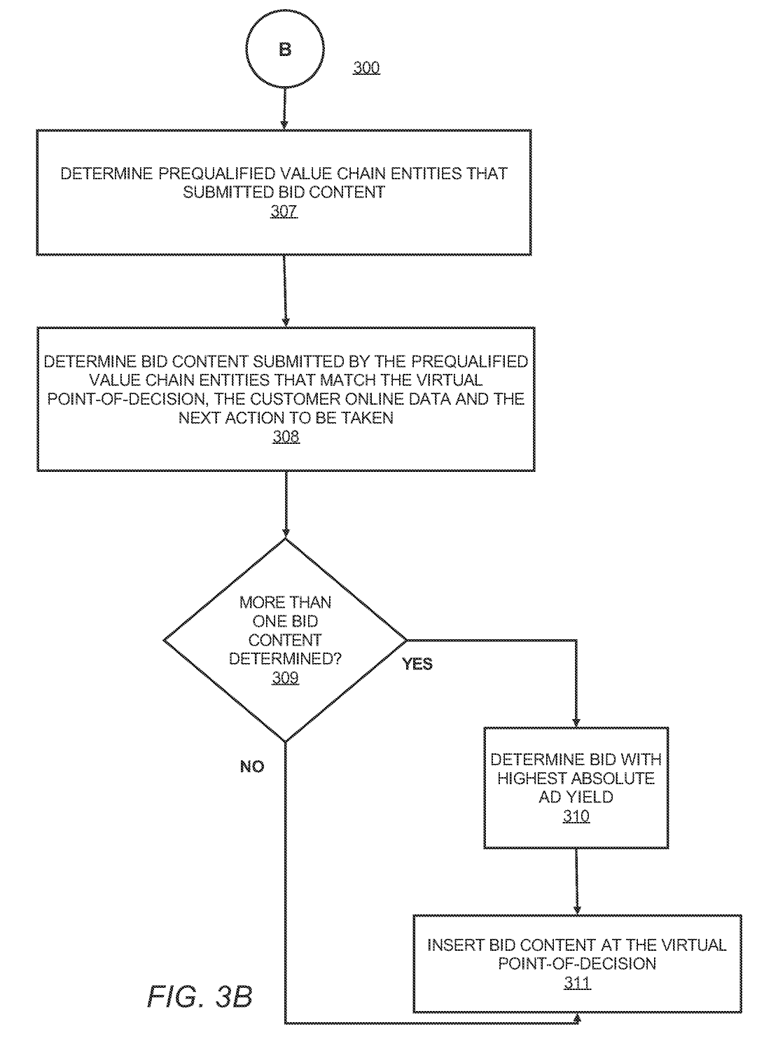

FIGS. 3A and 3B illustrate method 300 for determining whether to present online bid content from a prequalified value chain entity at a virtual point-of-decision, according to an embodiment. FIG. 3A illustrates steps 301-306. FIG. 3B illustrates steps 307-312. The method 300 is described with respect to the system 100 shown in FIGS. 1 and 2 by way of example and not limitation. The method 300 may be performed by other systems.

At step 301, the system 100 collects online customer data for a customer visiting a retailer web site. Online customer data may include attributes of the customer including family information, gender, geographical location, buying habits, customer tracking information such as current location of the customer in the retailer web site, etc. The online customer data is stored in an online customer database.

At step 302, the system 100 retrieves the online customer data for the customer at the virtual point-of-decision and determines a customer segment that corresponds to the attributes in the online customer data for the customer at the virtual point-of-decision and stores the correlation in a customer segmentation database.

At step 303, the system 100 determines whether the customer is at a virtual point-of-decision. As discussed above, the virtual point-of-decision is any online environment where a customer is presented with a set of product options or has selected from a set of product options, and an opportunity to influence customer selection exists. To determine whether the customer is at a virtual point-of-decision, the system 100 uses the online customer data retrieved at step 302. As discussed above, the online customer data may include an attributes describing a current location in the retailer web site. The attribute describing the current location of the customer in the web site is compared with known virtual points-of-decision of the retail web site. If attribute describing the current location of the customer in the web site matches a known virtual point-of-decision, the customer is at a virtual point-of-decision. If a customer is not at a virtual point-of-decision, the process proceeds to step 304. If the customer is at a virtual point-of-decision, the process proceeds to step 306.

At step 304, the system 100 prepares product recommendations for the customer. The product recommendations may include product features, coupons, or other calls to action for a product not within a category of product that the customer already purchases. The categories of products that the customer currently purchases is determined from corresponding online customer data retrieved from the online customer database at step 302.

At step 305, the system 100 presents product recommendations to the customer on the web site.

At step 306, the system 100 determines a next most profitable action to take with regard to the customer. As discussed above, customer-centric modeling takes into account growing customer lifetime value in determining the next most profitable action. The system 100 determines the next most profitable action to take with regard to the customer at the virtual point-of-decision to grow customer lifetime value based on historical models, customer behavior and purchase data, etc. For example, the next most profitable action may include implementing a strategy to move the customer to a house-brand product from a branded product, to encourage the customer to buy more volume in an existing product category, etc.

At step 307, the system 100 determines prequalified value chain entities from a group of value chain entities. The prequalified value chain entities are determined based on data from profiles of the value chain entities retrieved from a value chain entity database. As discussed above, the profiles of the value chain entities include “products manufactured” data. The products manufactured are compared with the product recommendation of the next most profitable action. If the products manufactured data matches the next most profitable action product recommendation, the value chain entity is the one of the prequalified value chain entities. The retailer may also require other criteria of the product manufacturers to be prequalified value chain entities, such as the prequalified value chain entities have an inventory of the product, the prequalified value chain entities be in a specific geographical location, etc.

At step 308, the system 100 scans a bid content database for online bid content submitted by the prequalified value chain entities that may be inserted at the virtual point-of-decision for the customer 101a. The bid content is determined by comparing the virtual point-of-decision of the bid content, which may be determined from the bid content database, to the virtual point-of-decision the customer is located at, which may be determined from the online customer data from the online customer database. The bid content is determined by comparing the next most profitable action and customer segment of the bid content in the bid content database with the product type and the customer segment of the customer. More than one bid content may be determined at step 308.

At step 309, the system 100 determines if more than one bid content is determined at step 308. If there is more than one bid content determined at step 308, the process proceeds to step 310. However, if it is determined that one bid content was determined, the process proceeds to step 311 without performing step 310.

At step 310, the system 100 determines the bid content with the highest absolute ad yield to be inserted at the virtual point-of-decision for the customer. The process then proceeds to step 311.

At step 310, the system 100 then inserts the bid content determined at step 309 or 310 at the virtual point-of-decision for the customer.

### 4. Computer System

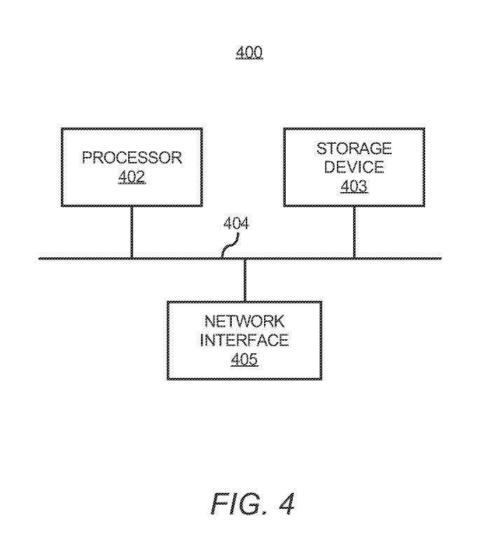

According to an embodiment, the system 100 may also be an agent running on equipment belonging to the retailer or a third party, a system accessed via the Internet, a web service, etc. FIG. 4 shows a computer system 400 that may be used as a hardware platform for the system 100, according to an embodiment. The computer system 400 may be used as a platform for executing one or more of the steps, methods, and functions described herein that may be embodied as software stored on one or more non-transitory computer readable mediums, such as storage devices. The modules may be software, hardware or a combination of both software and hardware.

The computer system 400 includes a processor 402, unit or processing circuitry that may implement or execute software instructions performing some or all of the methods, functions and other steps described herein. Commands and data from the processor 402 are communicated over a communication bus 404. The computer system 400 also includes a non-transitory computer readable storage device 403, such as random access memory (RAM), where the software and data for processor 402 may reside during runtime. The storage device 403 may also include non-volatile data storage. The computer system 400 may include a network interface 405 for connecting to a network. It will be apparent to one of ordinary skill in the art that other known electronic components may be added or substituted in the computer system 400.

While the embodiments have been described with reference to examples, those skilled in the art will be able to make various modifications to the described embodiments without departing from the scope of the claimed embodiments. Also, the embodiments described herein may be used to determine brands or products customers prefer, inserting ads at any point during an online transaction, etc.

What is claimed is:

1. A system for determining whether to present online bid content from a prequalified value chain entity at a virtual point-of-decision on a web site, comprising:
an online customer database storing online customer data;
a product manufacturer database storing prequalified value chain entity profiles; and
a dynamic arbitration engine executed by a computer system and including
a virtual point-of-decision module configured to determine whether a customer is at the virtual point-of-decision on the web site;
a customer segmentation module configured to determine a customer segment of the customer based on the online customer data;
a customer-centric modeling module configured to determine a next most profitable action based on the customer segment of the customer;
a prequalified value chain entities determination module configured to determine prequalified value chain entities based on product manufactured;
a bid content determination module configured to determine the bid content that may be presented to the customer at the virtual point-of-decision based on the customer segment of the customer and a product type; and
an bid content insertion module configured to insert the bid content determined by the bid content determination module at the virtual point-of-decision.

2. The system according to claim 1, wherein the virtual point-of-decision is an online environment where a customer is presented with a set of product options.

3. The system according to claim 1, wherein the virtual point-of-decision being a point at which a customer selection is influenced by the prequalified value chain entity.

4. The system according to claim 1, further comprising a bid content database storing a plurality of bid content submitted by the prequalified value chain entities from which the bid content to be inserted is determined.

5. The system according to claim 4, wherein the plurality of bid content in the bid content database are scanned to determine a bid content of the plurality of bid content having a matching customer segment to the customer at the virtual point-of-decision and a matching product type to the next most profitable action product recommendation.

6. The system according to claim 1, wherein if the bid content determination module determines more than one bid content that may be presented to the customer at the virtual point-of-decision based on the customer segment of the customer and the product type, the bid content determination module further determines one bid content from the more than one bid content with a highest absolute ad yield.

7. The system according to claim 6, wherein the absolute ad yield is a measure of profits associated with the bid content.

8. A method for determining whether to present online bid content from a prequalified value chain entity at a virtual point-of-decision on a web site, comprising:
determining, by a computer system, whether a customer is at the virtual point-of-decision on the web site;
determining a customer segment of the customer based on online customer data;
determining a next most profitable action based on the customer segment of the customer;
determining prequalified value chain entities based on product manufactured by the prequalified value chain entities;
determining bid content operable to be presented to the customer at the virtual point-of-decision based on the customer segment of the customer and a product type; and
inserting the bid content at the virtual point-of-decision.

9. The method according to claim 8, wherein the virtual point-of-decision is an online environment where a customer is presented with a set of product options.

10. The method according to claim 8, wherein the virtual point-of-decision being a point at which a customer selection is influenced.

11. The method according to claim 8, further comprising storing a plurality of bid content submitted by the prequalified value chain entities from which the bid content to be inserted is determined.

12. The method according to claim 11, further comprising scanning the plurality of bid content to determine an bid content having a matching customer segment to the customer at the virtual point-of-decision and a matching product type to the next most profitable action product recommendation.

13. The method according to claim 8, wherein if more than one bid content is determined that may be presented to the customer at the virtual point-of-decision based on the customer segment of the customer and the product type, determining one bid content from the more than one bid content with a highest absolute ad yield.

14. The method according to claim 13, wherein the absolute ad yield is a measure of profits associated with the bid content.

15. A non-transitory computer readable medium having stored thereon a computer executable program for determining whether to present online bid content from a prequalified value chain entity at a virtual point-of-decision on a web site, the computer executable program, when executed, causes a computer system to perform a method comprising:
determining whether a customer is at the virtual point-of-decision on the web site;
determining a customer segment of the customer based on online customer data;
determining a next most profitable action based on the customer segment of the customer;
determining prequalified value chain entities based on product manufactured by the prequalified value chain entities;
determining bid content operable to be presented to the customer at the virtual point-of-decision based on the customer segment of the customer and a product type; and
inserting the bid content at the virtual point-of-decision.

16. The computer readable medium according to claim 15, wherein the virtual point-of-decision is an online environment where a customer is presented with a set of product options.

17. The computer readable medium according to claim 15, wherein the virtual point-of-decision being a point at which a customer selection is influenced.

18. The computer readable medium according to claim 15, wherein the method further comprises:
storing a plurality of bid content submitted by the prequalified value chain entities from which the bid content to be inserted is determined.

19. The computer readable storage device according to claim 18, wherein the method further comprises:
scanning the plurality of bid content to determine a bid content having a matching customer segment to the customer at the virtual point-of-decision and a matching product type to the next most profitable action product recommendation.

20. The computer readable storage device according to claim 15, wherein if more than one bid content is determined that may be presented to the customer at the virtual point-of-decision based on the customer segment of the customer and the product type, determining one bid content from the more than one bid content with a highest absolute ad yield.
